(19) United States
(12) Patent Application Publication
(10) Pub. No.: US 2025/0229436 A1
(43) Pub. Date: Jul. 17, 2025

(54) MODULAR ROBOTIC ULTRASOUND PROBE GRIPPER WITH AUTONOMOUS GEL DISPENSER

(71) Applicant: Purdue Research Foundation, West Lafayette, IN (US)

(72) Inventors: Deepak Raina, Delhi (IN); Ziming Zhao, West Lafayette, IN (US); Richard Meredith Voyles, West Lafayette, IN (US); Juan P. Wachs, West Lafayette, IN (US)

(21) Appl. No.: 19/007,167

(22) Filed: Dec. 31, 2024

Related U.S. Application Data
(60) Provisional application No. 63/620,115, filed on Jan. 11, 2024.

(51) Int. Cl. B25J 15/00; B25J 11/00; B25J 13/08

(52) U.S. Cl. CPC B25J 15/0028; B25J 11/0075; B25J 13/084

(57) ABSTRACT

An apparatus may include a modular gripper which holds an ultrasound probe. The apparatus my include a gel detection sensor which detects the sufficiency of gel on the region of patient's body that receives the gel. The apparatus may include a gel dispenser device which release gel onto the region in response to the signal from a gel detection sensor.

### TECHNICAL FIELD

This disclosure relates to robotic ultrasound systems and, in particular, to robotic grippers for holding ultrasound probes with autonomous gel dispensing using a gel detection sensor.

### BACKGROUND

In present ultrasound practice, a probe is placed in contact with the target scanning region of the human body surface. The operator then manipulates the probe with his one hand, interprets the image quality, changes the probe if required and at the same time applies a gel using his other hand when required during the procedure. The gel is usually contained in a bottle that the operator needs to first uncap, turn over, place it near the probe and then squeeze it while avoiding touching or harming the patient being scanned. Later the bottle needs to be recapped every time to maintain the sterility and viscosity of the gel. In addition, the operator controls the settings of the ultrasound machine, such as depth, gain, and focus, using the buttons on the machine during the procedure. As a result, the operator is subjected to multiple obligatory constraints not only for the acquisition of imaging of sufficient quality to conduct an effective, high-quality examination but also for the performance of his equipment and the effectiveness and promptness of the examinations.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a front view of an apparatus with a probe gripper, a gel dispenser, and a gel detection sensor.

FIG. 2 illustrates a side view of an apparatus.

FIG. 3 illustrates a rear view of an apparatus.

FIG. 4 illustrates an example of a modular probe gripper.

FIG. 5 illustrates an example of a gel dispenser.

FIG. 6 illustrates an actuator-syringe coupler.

FIG. 7 illustrates a logic flow diagram for controlling the gel dispenser using a gel detection sensor.

FIG. 8 illustrates an example of a system with an apparatus.

### DETAILED DESCRIPTION

Recently, robotic ultrasound systems have been proposed for reducing the cognitive load on the operator. These robotic systems operate either in teleoperated or autonomous mode. The teleoperated systems have benefitted the rural and underserved populations by providing expert doctor services from the urban areas. The teleoperated systems also ensure the safety of the operator and have remained quite effective during the COVID-19 pandemic. The automated systems relieve the burden of expert doctors by autonomously interpreting the image and manipulating the probe.

In the current telerobotic or autonomous ultrasound systems, the gel is applied by the attendant at the patient site. This human intervention required in between the procedure for gel applications requires the robotic procedure to be halted several times. This increases the procedure time substantially and affects the image quality. In addition, for the current ultrasound procedures, the doctor utilizes different ultrasound probes based on the procedures for different body regions.

The existing robotic gripping solutions are cost-ineffective and cannot firmly grip all probes with different design specifications. Some ultrasound probes have built-in gel dispensing tubes built as part of the ultrasound machine setup. However, these solutions are either manually operated, probe-specific or require a high degree of coupling, which can present significant drawbacks to ongoing use and maintenance. For example, modification to ultrasound machines may often require replacing all the ultrasound probes that are already in use in several hospitals.

The system, apparatus, and methods disclosed herein describe a robotic ultrasound probe gripper that can hold probes of varying manufacture and autonomously detect and dispense the gel. The apparatus will increase the robustness of the robotic ultrasound system and eliminate the human intervention required for gel application.

The present disclosure provides a modular ultrasound probe gripper for a robotic arm to hold the different types of probes with variable cross-section at the point of grip. The gripper allows for easy attachment and detachment of the different probes by the operator, which is an essential requirement for robotic procedures. The gripper has two claws, one of which is fixed on one end and the other is mounted on the slider that can be moved manually along its pathway. The slider can be fastened using a knob provided on the fixed-end claw, which the operator can easily rotate with the hand to tighten the claw.

The present disclosure also includes a method to determine the sufficiency of the ultrasound gel at the contact surface between the ultrasound probe and the patient's body. The apparatus also includes one or multiple sensors, including cameras, ultrasound probes, force sensors or tactile sensors to detect the sufficiency of the gel on the skin. The detection is performed by a method specific to a sensor.

The present disclosure also provides an ultrasound gel dispenser to autonomously apply ultrasound gel to the surface of the patient's body. The dispenser will dispense the gel based on the detection by the sensor. The design includes a solid tube pointing at the side of the probe. The gel is applied through the tube on to the surface of the patient's body. The gel is dispensed by the compression of the piston inside the reservoir, which is obtained by the movement of the piston.

The design may include a signal transmission cable to be embedded with the motion control unit of the robotics arm. The signal transmission cable may allow an additional amendment to the amount of gel provided, including adjustment of the flow rate of gel when dispensing, request for complete start/stop of gel dispensing and halting the whole system in case of emergency.

The design may also include a button to allow the patient/individual near the patient to start/stop the gel dispensing process. This will allow the patients to terminate the process if they are not feeling comfortable. This will also be helpful in the telerobotic ultrasound system, which will allow the doctor to communicate with the patient from the remote site and request the patient to press the button in order to dispense the gel. Further, the button will allow doctors to apply the gel automatically in manual procedures if they are using the apparatus without being attached to the robotic arm.

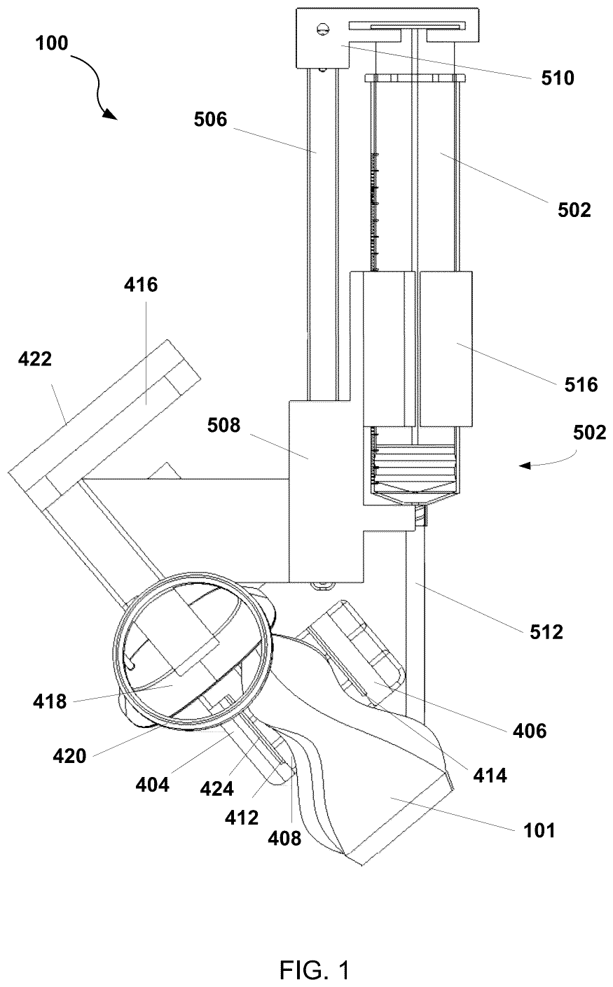

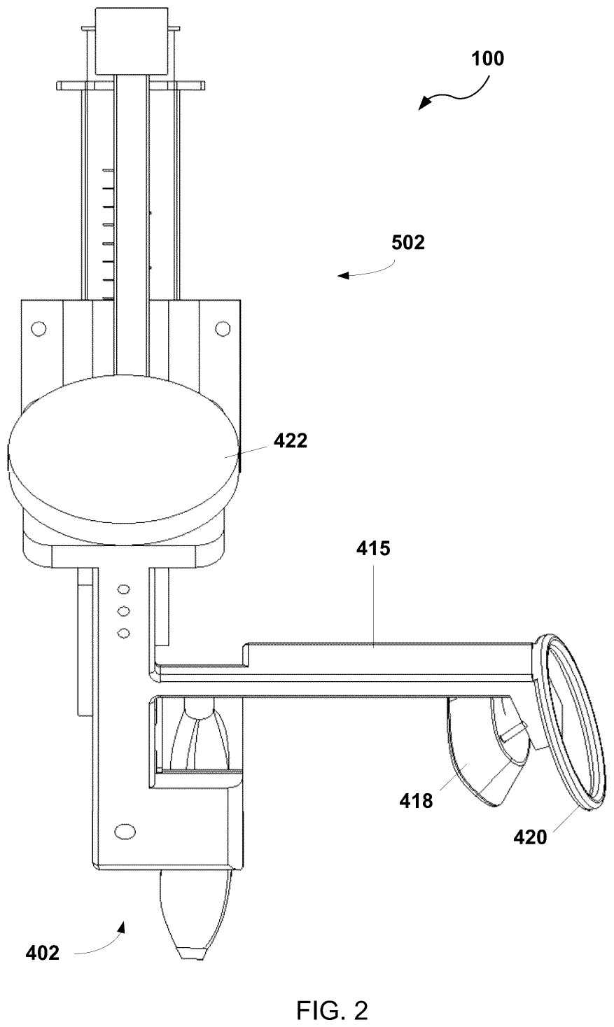

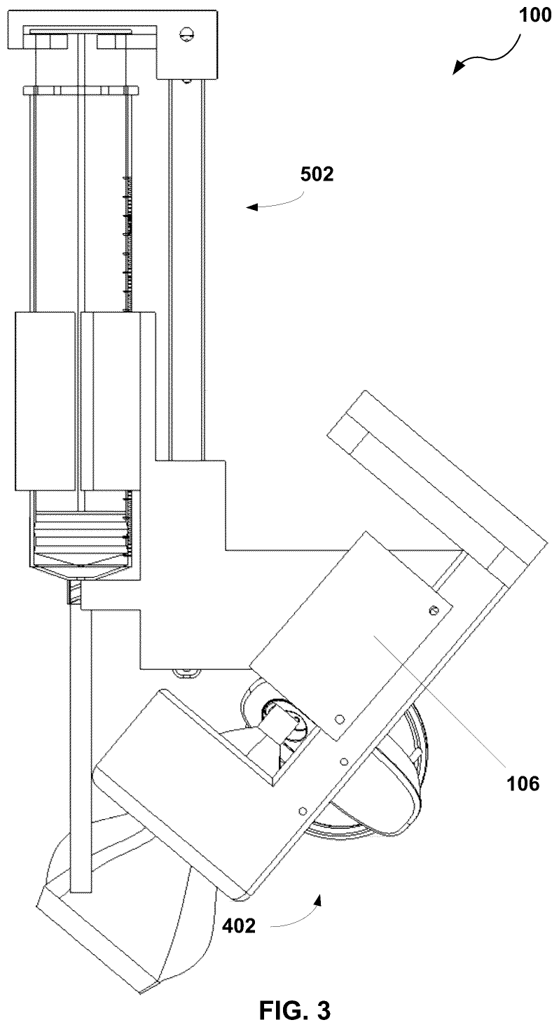

FIG. 1 illustrates a front view of an apparatus 100. FIG. 2 illustrates a side view of the apparatus 100. FIG. 3 illustrates a rear view of the apparatus 100. The apparatus may include a modular probe gripper 402 for gripping an ultrasound probe 101.

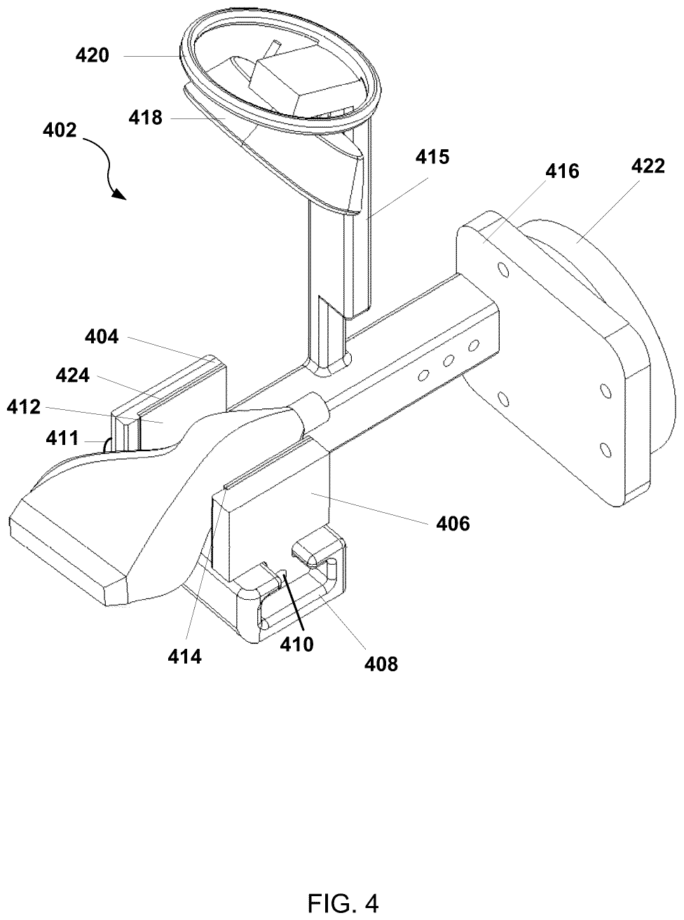

FIG. 4 illustrates an example of the modular probe gripper. A probe may be received between claws 404,406. The claws 404-406 may include a fixed claw 404 and a movable claw 406. The movable claw 406 may be connected to movable slider 408. The slider 408 may include a track in which the movable claw 406 slides. In some examples, the distance between the claws 404 and 406 may be controlled by a screw 410. The screw may be rotatable by a knob 411 for easy adjustment. The slider 408 can constrain the ultrasound probe at various lengths. Accordingly, the gripper design can be used for all kinds of standard ultrasound probes available commercially, including all the probes with different design specifications.

When the screw 410 is fastened, the distance between the claws 404, 406 will be adjusted. The claws 404, 406 will provide a force to retrain the probe. Rubber pads 412, 414 affixed to the inner surfaces of the claws 404, 406 provide extra friction to enhance the resistance. The rubber pads 412, 414 may be removed if the force supplied by the knob 411 itself is sufficient. The inside surface of the claw(s) may be shaped to the outer surface of the probe to improve the stability of the grip.

The knob-screw type fastening mechanism may reduce the complexity of the design. It allows the operator to change the probe without requiring any mechanical tools. The knob-screw type fastening mechanism may be replaced with a signal-triggered, motor-controlled claw to automatically close and open the claw(s). It will eliminate the minimal manual labor required by the operator to replace the probe. It will also allow the robot to automatically change the claw's width and pick up the probe from a predetermined location.

The modular probe gripper may further include a sensor arm 415. The sensor arm 415, which is used to attach to sensor(s) and/or camera(s). In addition, robotic arm connector 416 is included in the design. The connector allows the mounting of the apparatus on the robotic arm using the fasteners.

The module probe gripper may include a gel detection sensor. The sensor utilized may be multi-modal system to determine the sufficiency of gel applied in the vicinity of the probe. In the example apparatus, a camera serves as the primary gel detection sensor, employing an image-based method to assess gel sufficiency. This system may also incorporate supplemental mechanisms, such as lighting enhancements for improved visibility, friction coefficient measurements via force sensors, and tactile slip detection, to further ensure accurate and reliable assessment of gel sufficiency.

The gel detection sensor may include a camera 418 may mounted to the sensor arm 415. The camera 418 will capture a frame of the side of the probe and the surrounding area on the surface of a patient's body. When there is sufficient gel between the ultrasound probe and the surface of the patient body, there will be a gel trail left by the probe. The image obtained by the camera in that area will be used to determine the sufficiency of the gel between the probe and the surface of the patient body. The image obtained will pass through a feature extraction algorithm to determine the region of gel. If the gel is not detected, additional gel will be supplied to the system.

In the example apparatus, the camera may be placed in a position where the view of the camera includes part of the ultrasound probe and a region of the surface of the patient's body. As there is only one camera in the example apparatus, the gel detection can only one be done along one direction. The gel detection in the other direction can be done after the rotation and movement of the probe toward that direction. The multiple cameras may be attached to the current apparatus in different directions of the probe's movement to collect data about the gel trail left by the probe in other directions.

The detection algorithm used for the exemplary embodiment is the Faster Region-based Convolutional Neural Network (F-RCNN). A labeled dataset is created for training the F-RCNN. The dataset is built with pictures of different amounts of gel on people with different skin conditions. The dataset is labeled for the Region of Interest (Rol) with a rectangular entity containing the gel on the surface of the patient's body. During runtime, the model will detect multiple ROIs having confidence values associated with each Rol. The Rol with maximum confidence will be considered as the region covered by ultrasound gel on the patient's body. Those regions will be used to detect if the movement of the ultrasound probe leaves a trail of the ultrasound gel on the patient's body. The existence of the gel is determined by the trail existing in the region probe just passed. If no Rol is detected or confidence of detected Rol is below the threshold, it indicates that the gel is not sufficient for further scanning by the probe.

A light sources 420, such as white light source, may be introduced to accommodate the lack of illumination in the room of the procedure. As the gel usually has a better reflection ratio than the skin, it will be determined easier with a brighter environment. Additional colored light sources may be introduced to utilize the reflective property of the gel to improve the performance of the gel detection on the skin. The more apparent border will increase the success rate of detection.

The quality estimation of ultrasound images may be leveraged to determine the sufficiency of gel. The ultrasound images acquired with inappropriate gel will have relatively low quality, however, ultrasound images acquired using appropriate gel condition will have high-quality value. The threshold value for the quality measure can be set to determine the sufficiency of gel. The gel identification module can use various quality estimation methods, including contrast estimation, pixel-based image analysis and learning-based image classification. The learning-based techniques require a labelled ultrasound image dataset, which can be used to learn a supervised model for classifying the image quality.

Alternatively or in addition, the gel detection sensor may include a force sensor 422 may be used with the apparatus to estimate the friction coefficient between the probe and the surface. The surface having appropriate gel quantity will have a low friction coefficient, however, the surface with inappropriate gel will have high friction coefficient. The threshold value for the coefficient can be predefined to distinguish between these conditions. The coefficient is determined by the ratio of the normal force to the tangential force, which can be measured by the force sensor. Either the wrist sensor of a robotic arm can be used, or the external force sensor can be attached to the apparatus for the measurement of forces. For multi-directional force measurement, a 6-axis force/torque sensor can be used to measure force and torque data across all axes.

Alternatively or in addition, the gel detection sensor may include a tactile sensor 424 may be used with the apparatus to estimate the slip between the probe and the surface. These sensors will detect the incipient slip, which provides richer slip information at the beginning of the slip before the macro slip occurs. In the current apparatus, the slip between the probe and surface is a necessary condition and detecting the incipient slip will help ensure the gel's sufficiency at all contact points of the probe. If an incipient slip is occurring between the probe and the surface, it indicates that sufficient gel is not present. The tactile sensors 424 may be embedded between the claws 404, 406 and rubber pads 412, 414 of the apparatus. This configuration enables the sensors to monitor the force distribution between the claws, probe, and the patient's skin, allowing them to infer gel sufficiency indirectly. Alternatively, tactile sensors can be integrated directly onto the contact surface of the probe, enabling direct measurement of slip and friction forces at the precise interface where the gel is applied. While this direct placement ensures highly accurate detection of slip events, it would require redesigning the ultrasound probe, as such configurations are not typically found in commercially available models. The different tactile sensors using micro-vibration, shear strain distribution, or deformation field method can be used to quantify the slip state in the current apparatus.

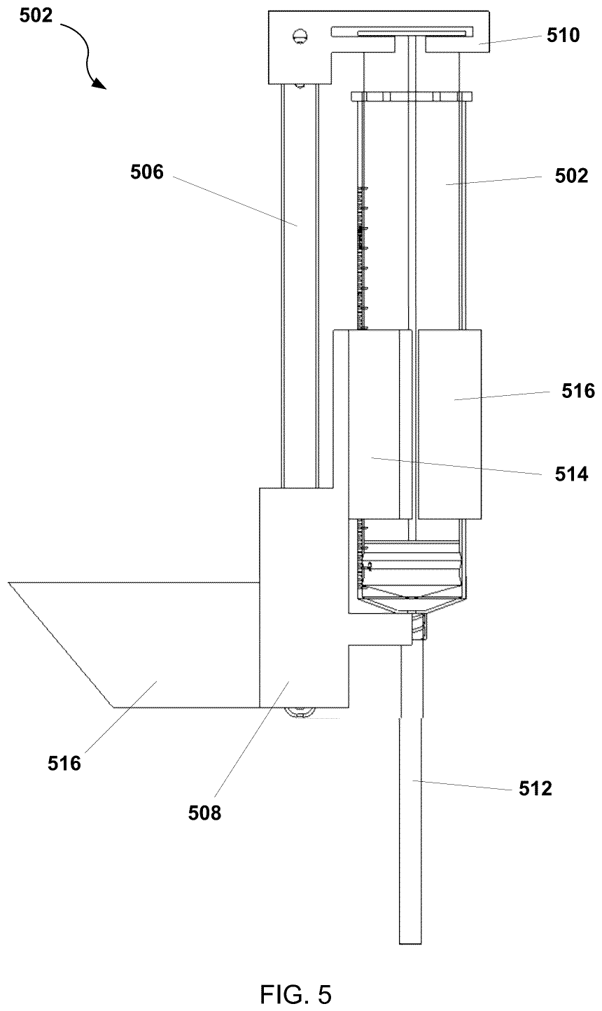

The apparatus may include a gel dispenser 502. FIG. 5 illustrates an example of the gel dispenser 502. The gel dispenser 502 may include a syringe 504 and a linear actuator 506, to control the syringe. The syringe 504 may contain a gel that is used for ultrasound. The linear actuator 506 may be mounted on a linear actuator range limiter 508. The moving end of the linear actuator 506 is connected to the actuator-syringe coupler 510. As the linear actuator range limiter 508 limits one end of the linear actuator 506, the actuator-syringe coupler 510 will move to compress the syringe 502. The gel in the syringe will dispense through tube 512 towards the target area on the surface of the human body.

The syringe may be coupled and constrained by the left syringe mounting 514 and right syringe mounting 516. The hub of the syringe 502 is constrained by tween the syringe mounts 514 and 516 to stabilize the linear movement of the syringe. The syringe 502 can be replaced and refilled after finishing the scanning. Larger containers may be included in the design in order to reduce the frequency of refilling during the procedure. The syringe 502 can easily be removed by loosening a screw or some other tightening mechanism.

The left syringe mounting 514 and right syringe mounting 516 may have an inner surface near the outer diameter of the syringe. The syringe constraint may compress the syringe to fix it. The syringe constraint is designed to be removable, so the process of removing the syringe and refilling the gel becomes easier. An additional rubber pad in the inner surface of the mounting may be involved to provide a larger friction force to stabilize the system.

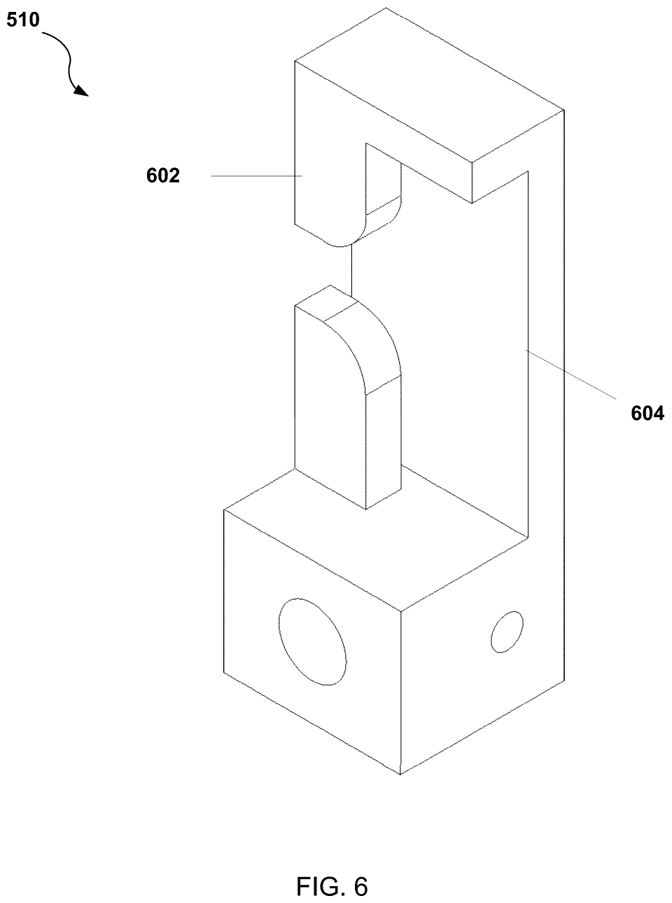

The gel dispenser tube 512 may be combined with the syringe for easier replacement. The tube 512 may be built with a uniform cross-section to reduce pressure to supply the gel. If a large pressure mechanism is available, the tube cross-section may be changed to follow the outer surface of the gripper up to the contact point to make the design more compact. FIG. 6 illustrates an example of an actuator-syringe coupler 510. The one end of this coupler is connected to the end of linear actuator and other end is connected to the back end of piston in syringe. When the linear actuator is given the command to move either up or down, it will move the piston in the syringe, thereby controlling the gel dispensing on the patient's skin. The coupler also allows the actuator-syringe assembly to be easily decoupled by simply rotating it in the direction of its open end 602, which allows easy detachment of syringe to refill it whenever required during the procedure. The constraint end of the coupler 604 rigidly holds the piston of the syringe. The half-sided coupling also protects the linear actuator from high shear strength.

Referring back to FIG. 3, the system may include a controller 106. The controller may include an embedded controller or any other type of hardware processor or computer as described herein. The controller may interface with the sensor(s) and/or camera described herein. The controller may execute all or part of the logic described herein.

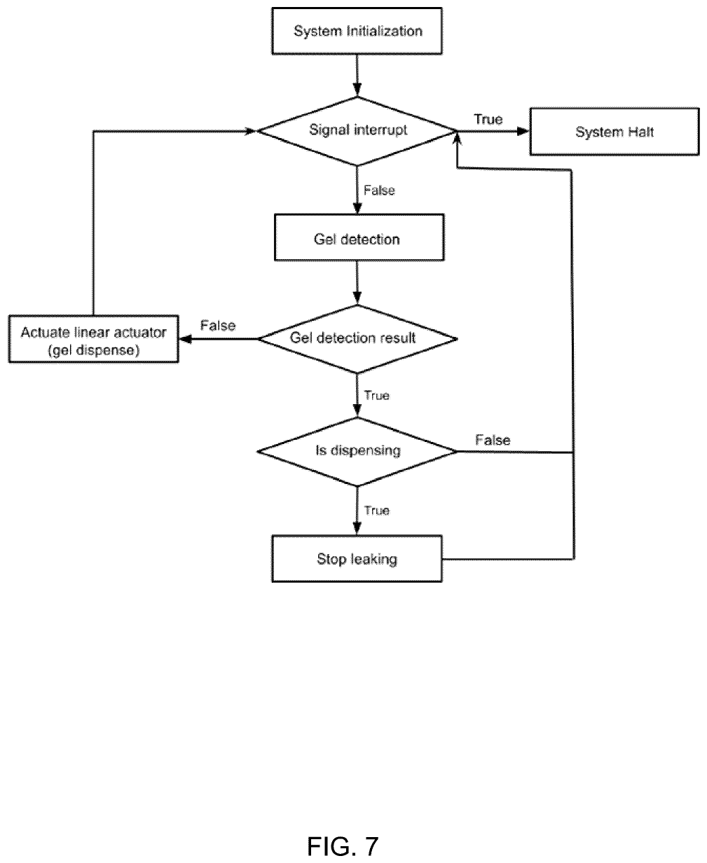

FIG. 7 illustrates an example logic to operate the apparatus 100. The actuation process of the linear actuator of this example embodiment is demonstrated as a logical flow graph. After the controller is initiated, it will check if there are signals which require the halt of the system. If no system halt is required, it will detect the sufficiency of the gel. If the gel does not exist in sufficient quantity, it will call the control program of the linear actuator and let it compress the syringe to release the ultrasound gel. If the gel exists in the appropriate quantity, it will check whether the gel dispenser is currently releasing it or not. If the gel dispenser is not dispensing, it will start checking the signal for a halt and repeat the steps above. If the gel dispenser is dispensing, it will stop the process with the linear actuator moving in the reverse direction to lower the pressure in the syringe. This step can prevent the system from further leaking the gel. After that, it will check the signal for a halt and repeat the steps above.

The doctor may also use the apparatus independently for automatic gel dispensing during manual procedures. The apparatus may improve the efficiency of the manual procedure, as the additional time for the manual tilting and compressing of the gel container is not required. The doctor will need additional training to perform the procedure in this modified setting.

All or apportion of the logic described herein may be implemented by a controller. The controller may, in some circumstances, be an embedded controller 16, as illustrated in FIG. 3. Alternatively or in addition, the logic may be implemented by a processor or other logic hardware on or separate from the apparatus.

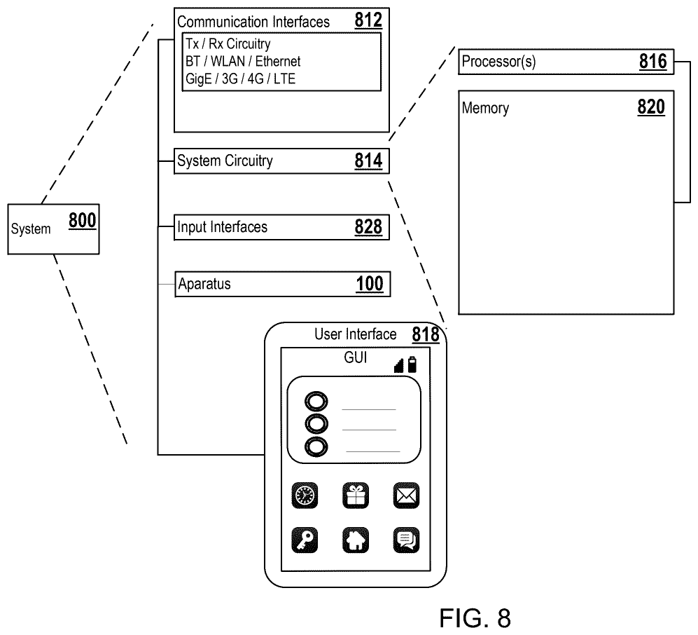

FIG. 8 illustrates an example of a system 800. The system 800 may include the apparatus 100 (previously described herein), communication interfaces 812, input interfaces 828 and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform operations to control the apparatus 100. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 800 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The system 800 may be implemented in many different ways. In some examples, the system 800 may be implemented with one or more logical components. For example, the logical components of the system 800 may be hardware or a combination of hardware and software. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. An apparatus comprising:
a modular gripper configured to hold an ultrasound probe; and
a gel detection sensor configured to detect the sufficiency of gel on the region of patient's body that receives the gel; and
a gel dispenser device configured to release gel onto the region in response to the signal from a gel detection sensor.

2. The apparatus of claim 1, wherein the gripper comprises a plurality of claws configured to hold an ultrasound probe with a maximum thickness between 10 mm to 200 mm.

3. The apparatus of claim 2, further comprises a slider housing, wherein the claws comprise a first claw and a second claw, wherein the first claw is fixed to a first end of the slider housing and the second claw is adjustable in the slider housing to vary the distance between the claws.

4. The apparatus of claim 3, wherein at least one of the claws is constrained by a long-threaded screw.

5. The apparatus of claim 4, wherein the long-threaded screw includes a hand-adjustable knob on one end.

6. The apparatus of claim 4, wherein the gel detection sensor comprises a tactile sensor located on at least one of the first claw and the second claw.

7. The apparatus of claim 1, wherein the gel detection sensor estimates the sufficiency of gel on the surface in contact with the probe.

8. The apparatus of claim 7, wherein detection of gel between the probe and patient's body is based on either one or multiple methods, including:
an extraction of the gel region by analyzing the image captured by the camera; and
a quality evaluation of the acquired ultrasound image; and
a measure of the friction coefficient between the probe and contact surface using a force sensor; and
a detection of incipient slip between probe and contact surface using a tactile sensor.

9. The apparatus of claim 8, wherein the actuation of the gel dispenser is dependent on the detection of gel on the surface.

10. The apparatus of claim 1, wherein the gel dispenser comprises a reservoir for ultrasound gel, an actuator to pressurize the gel, and a tube to dispense the gel.

11. The apparatus of claim 10, wherein the reservoir comprises a syringe with one fixed end.

12. The apparatus of claim 10, wherein the actuator is a linear actuator configured to compress the syringe to dispense the ultrasound gel.

13. The apparatus of claim 10, wherein the actuator is connected to the reservoir with a removable connection to allow replacement and refilling of the reservoir.

14. The apparatus of claim 10, wherein the tube is pointed to a forwarding path of a probe contained in the gripper.

15. The apparatus of claim 1, wherein the gripper is connected to a plate configured to mount to a robotic arm.

16. The apparatus of claim 1, further comprising a processor, wherein the processor is configured to:
receive the signal from the gel detection sensor;
determine a sufficiency of an amount of gel on the region of the patient's body; and
cause the gel despensor device to release the gel in response to the amount of gel on the region of the patient's body be insufficient.
